(19) United States
(12) Patent Application Publication
(10) Pub. No.: US 2026/0267634 A1
(43) Pub. Date: Sep. 10, 2026

(54) VEHICLE SOFTWARE UPDATE SYSTEM

(71) Applicant: Astemo, Ltd., Chiyoda-ku, Tokyo (JP)

(72) Inventor: Hiroyuki HANYU, Hitachinaka-shi, Ibaraki (JP)

(73) Assignee: Astemo, Ltd., Chiyoda-ku, Tokyo (JP)

(21) Appl. No.: 19/166,728

(22) PCT Filed: May 30, 2023
(86) PCT No.: PCT/JP2023/020038

§ 371 Date: Sep. 18, 2025

(51) Int. Cl. G06F 8/65

(52) U.S. Cl. CPC G06F 8/65

(57) ABSTRACT

A server of a vehicle software update system that manages software updates of a plurality of function-specific ECUs in a vehicle after transfer includes: an acquisition unit A that acquires mounted function information of a vehicle before transfer; an acquisition unit B that acquires mounted function information of the vehicle after transfer; an acquisition unit C that acquires user-selected function information from a user terminal; a difference extraction unit that extracts a difference among the mounted function information of the vehicle before transfer, the mounted function information of the vehicle after transfer, and the user-selected function information; and an update processing determination unit that selects necessary software update processing according to a content of the difference and generates update function information. A vehicle control device of a vehicle after transfer includes a software update determination unit that controls software update and priority in a plurality of function-specific ECUs according to update function information distributed from a server, and each of the plurality of function-specific ECUs of the vehicle after transfer includes a software update processing unit that executes a software update method notified from the vehicle control device of the vehicle after transfer.

### TECHNICAL FIELD

The present disclosure relates to a vehicle software update system.

### BACKGROUND ART

With multi-functionalization and high-functionalization of automatic driving or advanced driving support functions, there is a demand for continuous use of functions and settings emphasized by a user in a case of driving a vehicle for the first time, such as a newly purchased vehicle or a rental car, or in a case of driving a vehicle in a state after another person drives the vehicle. In addition, driving a new vehicle in an unfamiliar state may lead to an accident. In order to solve the problem, car personalization (car personalization) is effective.

For example, Patent Literature 1 discloses a technique of transmitting a user-preferred setting customized by a user to an in-vehicle electronic control unit to be rewritten and operating the device with the user-preferred setting.

### CITATION LIST

### Patent Literature

PTL 1: JP 2014-182571 A

### SUMMARY OF INVENTION

### Technical Problem

In Patent Literature 1, a difference between a setting preferred by a new user and a setting preferred by an old user is extracted by comparing the user-preferred settings, but a functional difference between a vehicle before transfer and a vehicle after transfer is not described. In addition, the user-preferred setting is only data, and update of a function implemented by software is not considered.

An object of the present disclosure is to provide a vehicle software update system that allows a function emphasized by a user to be selectively set and can cope with personalization that improves convenience of the user.

In personalization, in a case where many functions are provided in advance and a user selection function is further added, there is a problem that memory exhaustion or an update time increases due to an increase in memory capacity. In addition, when the memory update is frequently performed, there is a problem that the memory life is shortened (failed).

### Solution to Problem

The present disclosure is a vehicle software update system including: a vehicle control device mounted on a vehicle; and a server that performs communication via a network,
the vehicle including a vehicle before transfer and a vehicle after transfer, and
the vehicle software update system managing software updates of a plurality of function-specific electronic control units in the vehicle after transfer, wherein
the server includes:
an acquisition unit A that acquires mounted function information of the vehicle before transfer;
an acquisition unit B that acquires mounted function information of the vehicle after transfer;
an acquisition unit C that acquires user-selected function information from a user terminal;
a difference extraction unit that extracts a difference among the mounted function information of the vehicle before transfer, the mounted function information of the vehicle after transfer, and the user-selected function information; and
an update processing determination unit that selects necessary software update processing according to the content of the difference and generates update function information based on the necessary software update processing, and
in the vehicle after transfer,
the vehicle control device includes a software update determination unit that controls software update and priority in the plurality of function-specific electronic control units according to the update function information distributed from the server, and
each of the plurality of function-specific electronic control units includes a software update processing unit that executes a software update method notified from the vehicle control device of the vehicle after transfer.

The function emphasized by the user can be acquired by the acquisition unit C. The acquisition unit A and the acquisition unit B can acquire difference information. The software update determination unit determines software to be updated by comparing the difference information with the information on the function that the user emphasizes acquired by the acquisition unit C (comparing the two pieces of information).

### Advantageous Effects of Invention

According to the present disclosure, since the software update of only the function necessary for the user and the difference portion is performed, the personalization of the vehicle after transfer can be realized, and there are effects that the update time of the software can be shortened, the capacity of the nonvolatile memory of the function-specific electronic control unit can be reduced, and the memory life of the nonvolatile memory of the function-specific electronic control unit can be extended.

### BRIEF DESCRIPTION OF DRAWINGS

FIG. 1 is a block diagram illustrating an overall configuration of a vehicle software update system according to a first embodiment.

FIG. 2 is a sequence diagram of the vehicle software update system according to the first embodiment.

FIG. 3 is a data flow diagram illustrating a software update method of the vehicle software update system according to the first embodiment.

FIG. 4 is a flowchart illustrating difference extraction processing according to the first embodiment.

FIG. 5 is a flowchart illustrating update processing determination according to the first embodiment.

FIG. 6 is an example of priority setting of each function-specific ECU according to a second embodiment.

FIG. 7 is a flowchart illustrating priority setting processing according to the second embodiment.

FIG. 8 is a flowchart for explaining ECU update processing according to the second embodiment.

FIG. 9 is a diagram illustrating a representative configuration example of a control device included in a function-specific ECU.

### DESCRIPTION OF EMBODIMENTS

Hereinafter, the present embodiment will be described with reference to the accompanying drawings. In the accompanying drawings, functionally same elements may be denoted by the same numbers. Note that, although the accompanying drawings illustrate embodiments and implementation examples conforming to the principles of the present disclosure, these are for understanding the present disclosure and are not used to interpret the present disclosure in a limited manner. The description herein is exemplary only and is not intended to limit the claims or applications of the present disclosure in any way.

In the present embodiment, the description has been made in sufficient detail for those skilled in the art to implement the present disclosure, but it is necessary to understand that other implementations and embodiments are possible, and changes in configurations and structures and replacement of various elements are possible without departing from the scope and spirit of the technical idea of the present disclosure. Therefore, the following description should not be interpreted as being limited thereto.

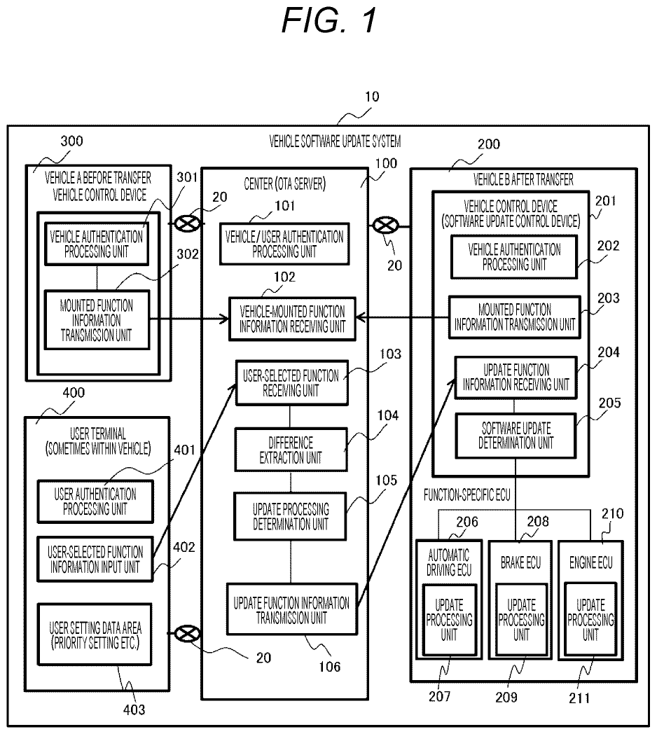

Hereinafter, embodiments of the present disclosure will be described with reference to FIGS. 1 to 9.

### First Embodiment

FIG. 1 is a block diagram illustrating an overall configuration of a vehicle software update system according to a first embodiment. A vehicle software update system 10 illustrated in FIG. 1 includes a center 100 that is an over the air (OTA) server, a vehicle 200 after transfer (vehicle B, second vehicle), a vehicle 300 before transfer (vehicle A, first vehicle), and a user terminal 400, which are connected to each other via a network 20. Examples of the network 20 include a mobile phone network, an Internet network, and the like. The vehicle software update system 10 is a system that manages software updates of a plurality of function-specific electronic control units (ECUs) 206, 208, and 210 in the vehicle 200 after transfer.

The center 100, which is a server, can communicate with the vehicle control devices 301 and 201 mounted on the vehicles 300 and 200 via the network 20. The center 100 receives mounted function information from the vehicle 200 after transfer, the vehicle 300 before transfer, and the user terminal 400 and transmits (distributes) update function information for updating software of each function-specific ECUs 206, 208, and 210 in the vehicle 200 after transfer via the network 20. The center 100 includes a vehicle/user authentication processing unit 101, a vehicle-mounted function information receiving unit 102, a user-selected function receiving unit 103, a difference extraction unit 104, an update processing determination unit 105, and an update function information transmission unit 106.

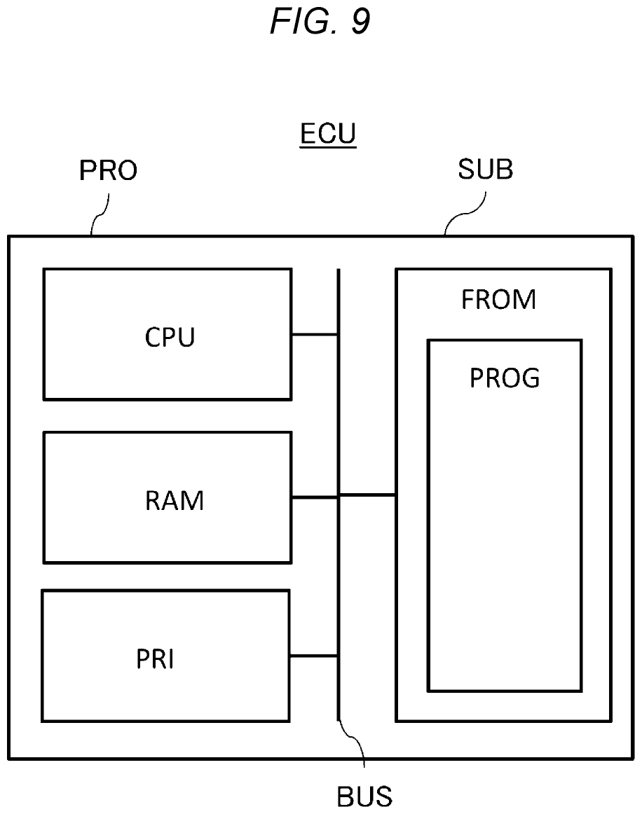

The vehicle 200 after transfer includes a vehicle control device 201 that performs software update control and a plurality of function-specific ECUs 206, 208, and 210. In this example, the plurality of function-specific ECUs 206, 208, and 210 are an automatic driving ECU 206, a brake ECU 208, and an engine ECU 210. The function-specific ECUs 206, 208, and 210 include update processing units (also referred to as software update processing units) 207, 209, and 211, respectively. The ECU mounted on the vehicle 200 after transfer is not limited to FIG. 1, and other ECUs may be mounted. FIG. 9 is a diagram illustrating a representative configuration example of a control device included in the function-specific ECU. In this example, as illustrated in FIG. 9, a processor PRO as a control device included in the function-specific ECU such as the automatic driving ECU 206, the brake ECU 208, and the engine ECU 210 is formed on one semiconductor substrate SUB formed of a single crystal such as silicon, for example. The processor PRO includes a central processing unit CPU capable of executing software, a random access memory RAM constituted by a volatile memory serving as a temporary work area of the central processing unit CPU, a flash type read-only memory FROM constituted by a nonvolatile memory that stores, as data, software PROG executed by the central processing unit CPU, a peripheral function circuit PRI, and a bus BUS. The flash type read-only memory FROM is a semiconductor memory capable of rewriting data that is software PROG. In the present embodiment, the flash type read-only memory FROM is a memory that stores updated software. The bus BUS connects the central processing unit CPU, the random access memory RAM, the flash type read-only memory FROM, and the peripheral function circuit PRI to each other.

The vehicle control device 201 includes a vehicle authentication processing unit 202, a mounted function information transmission unit 203, an update function information receiving unit 204, and a software update determination unit 205.

The vehicle 300 before transfer includes a vehicle authentication processing unit 301 and a mounted function information transmission unit 302. Although one or more ECUs are mounted on the vehicle 300 before transfer, the description thereof is omitted in FIG. 1 because it is not related to the present invention.

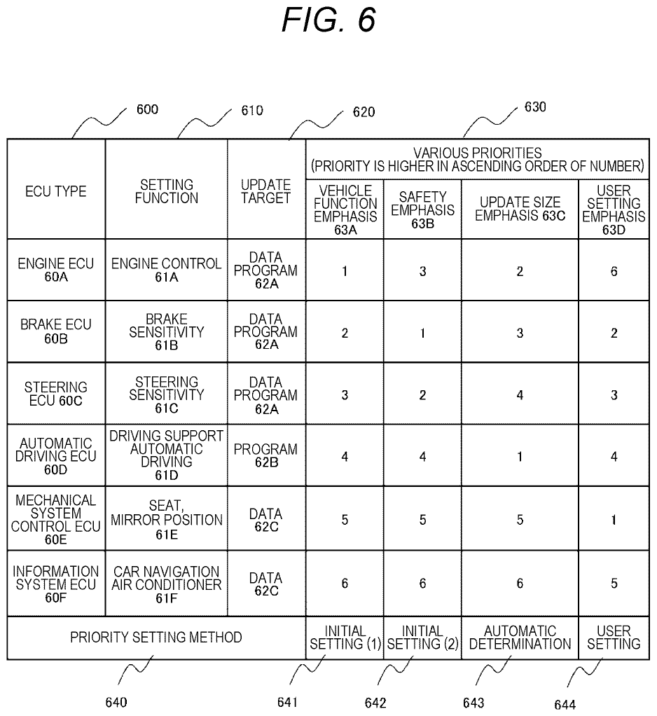

The user terminal 400 includes a user authentication processing unit 401, a user-selected function information input unit 402, and a user setting data area 403. The user terminal 400 is a dedicated terminal or a portable terminal (a tablet-type personal computer, a smartphone, or the like) carried by the user. After the user authentication, the user terminal 400 is connected to the center 100 and becomes available. Further, in the user setting data area 403, position information of seats and mirrors, brake and steering sensitivity information, priority setting data of functions (see FIG. 6), and the like are stored and transmitted to the center 100 as user-selected function information.

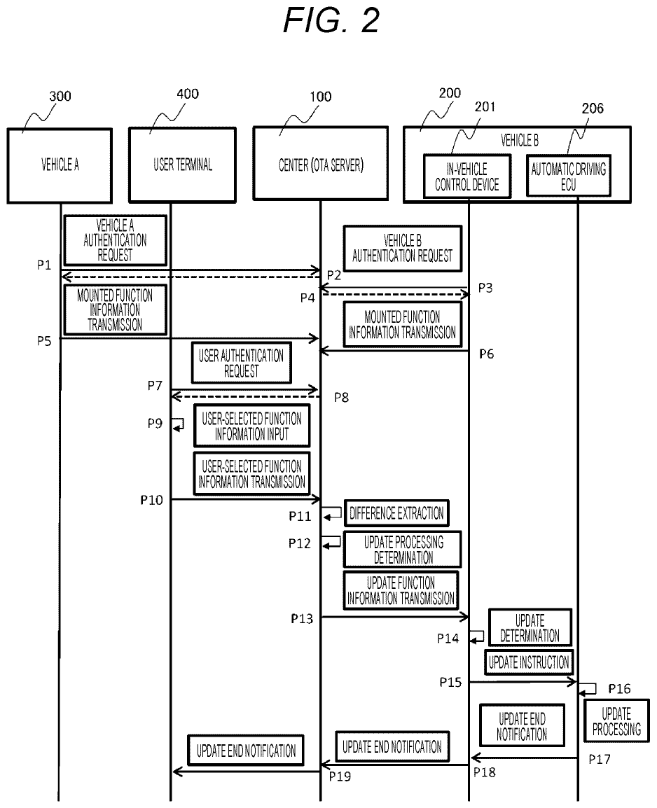

FIG. 2 is a sequence diagram of the vehicle software update system according to the first embodiment. The vehicle 300 before transfer transmits an authentication request from the vehicle authentication processing unit 301 to the center 100 (P1). The center 100 performs authentication in the vehicle/user authentication processing unit 101, and returns a completion notification after completion of the authentication (P2). The vehicle 200 after transfer transmits an authentication request from the vehicle authentication processing unit 202 to the center 100 (P3). The vehicle/user authentication processing unit 101 performs authentication, and returns a completion notification after completion of the authentication (P4). Thereafter, the vehicle 300 before transfer and the vehicle 200 after transfer transmit the mounted function information to the vehicle-mounted function information receiving unit 102 of the center 100 (P5, P6). That is, the vehicle-mounted function information receiving unit 102 includes a first acquisition unit (acquisition unit A) that acquires the mounted function information of the vehicle 300 before transfer from the mounted function information transmission unit 302, and a second acquisition unit (acquisition unit B) that acquires the mounted function information of the vehicle 200 after transfer from the mounted function information transmission unit 203.

The user terminal 400 transmits a user authentication request from the user authentication processing unit 401 to the center 100 (P7). The center 100 performs user authentication in the vehicle/user authentication processing unit 101, and returns a completion notification after completion of the authentication (P8). After completion of the authentication, the user inputs the user-selected function on the user-selected function information input unit 402 of the user terminal 400 (P9). After the input, the user terminal 400 transmits the user-selected function information to the user-selected function receiving unit 103 of the center 100 (P10). That is, the user-selected function receiving unit 103 includes a third acquisition unit (acquisition unit C) that acquires the user-selected function information (the mounted function information selected by the user) from the user-selected function information input unit 402. Note that the order of authentication of the vehicle 300 before transfer, the vehicle 200 after transfer, and the user terminal 400 is not limited to the above example, and the order can be changed. The authentication of each vehicle 300, 200 can also be performed constantly or periodically.

After the vehicle-mounted function information receiving unit 102 and the user-selected function receiving unit 103 receive the function information (mounted function information of the vehicle 300 before transfer, mounted function information of the vehicle 200 after transfer, and user-selected function information) transmitted from the vehicle 300 before transfer, the vehicle 200 after transfer, and the user terminal 400, the center 100 performs difference extraction by the difference extraction unit 104 (P11). Thereafter, the update processing determination unit 105 performs update processing determination (P12), and the update function information transmission unit 106 transmits (distributes) the update function information to the vehicle 200 after transfer (P13). The update processing determination unit 105 performs update processing determination according to the content of the difference, selects necessary software update processing, and generates update function information based on the necessary software update processing. The update function information transmission unit 106 transmits the update function information from the update processing determination unit 105 to the update function information receiving unit 204 of the vehicle 200 after transfer.

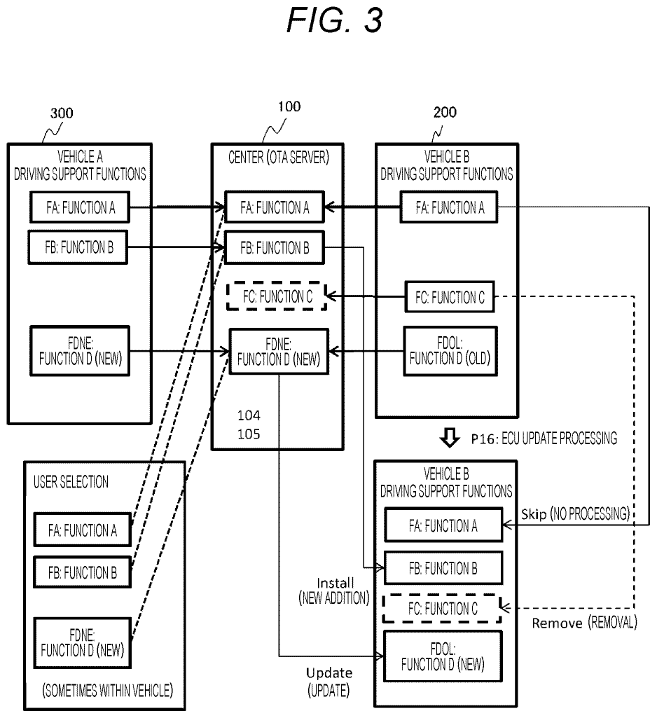

In the vehicle 200 after transfer, the update function information receiving unit 204 receives the update function information, and the software update determination unit 205 determines the software update content based on the update function information (P14). After determining the software update method, the software update determination unit 205 transmits an update instruction to each function-specific ECU (the software update processing unit 207 of the automatic driving ECU 206 in the example of FIG. 2) (P15). The software update determination unit 205 can be configured to be able to control software update and priority in the plurality of function-specific electronic control units 206, 208, and 210 as described in Example 2 to be described later. Regarding the priority, the description of Example 2 can be referred to. As a software update method, there are new addition (Install), removal (Remove), update (Update), and no processing (Skip). The method for updating the software can be referred to the description of FIG. 3 described later.

The automatic driving ECU 206 executes the update processing using the update processing unit 207 of the automatic driving ECU 206 according to the instruction by the notification from the software update determination unit 205 in the vehicle control device 201 of the vehicle 200 after transfer (P16). That is, each of the plurality of function-specific electronic control units 206, 208, and 210 includes software update processing units 207, 209, and 211 that execute the software update method notified from the software update determination unit 205 of the vehicle control device 201 of the vehicle 200 after transfer.

After completion of the update, update completion is notified to the vehicle control device 201 (P17). The vehicle control device 201 notifies the center 100 of the update completion (P18), and the center 100 sequentially notifies the user terminal 400 of the update completion (P19).

FIG. 3 is a data flow diagram illustrating a software update method of the vehicle software update system according to the first embodiment. The user-selected function information and the update method will be described with reference to FIG. 3.

For example, four functions of a function A (FA), a function B (FB), a function C (FC), and a function D (FD) are assumed as the automatic driving support functions in the automatic driving ECU 206. The vehicle 300 before transfer is mounted with the function A (FA), the function B (FB), and a function D (new version) (FDNE). The vehicle 200 after transfer is mounted with the function A (FA), the function C (FC), and a function D (old version) (FDOL). When the user selected the function A (FA), the function B (FB), and the function D (new version) (FDNE) as necessary functions, the center 100 determines the function necessary for the vehicle 200 after transfer and the update method by the difference extraction unit 104 and the update processing determination unit 105.

The vehicle 200 after transfer updates the software in the automatic driving ECU 206 according to the instruction from the center 100 (ECU update processing: P16). In the example of FIG. 3, since there is no change in the function A (FA), no processing is performed (Skip), the function B (FB) is newly added (Install), the function C (FC) is removed (Remove), and the function D (FD) is updated (Update) from the old version (FDOL) to the new version (FDNE). By using the difference information as described above, it is possible to suppress an increase in the rewrite time and the storage capacity (capacity of the software PROG) of the software PROG of the flash type read-only memory FROM. Therefore, according to the present embodiment, effects such as reduction of the storage capacity of the flash type read-only memory FROM, reduction of the update time, and extension of the memory life of the flash type read-only memory FROM can be obtained. Since the flash type read-only memory FROM has a characteristic that the life is shortened when the stored content is frequently rewritten, the life of the flash type read-only memory FROM can be extended by reducing the number of times of rewrite (update).

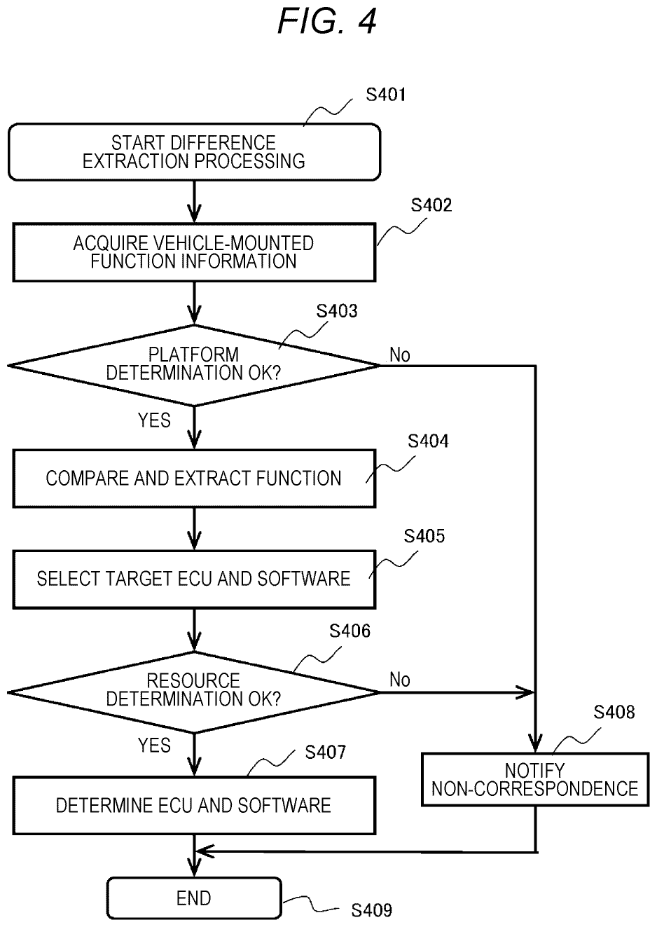

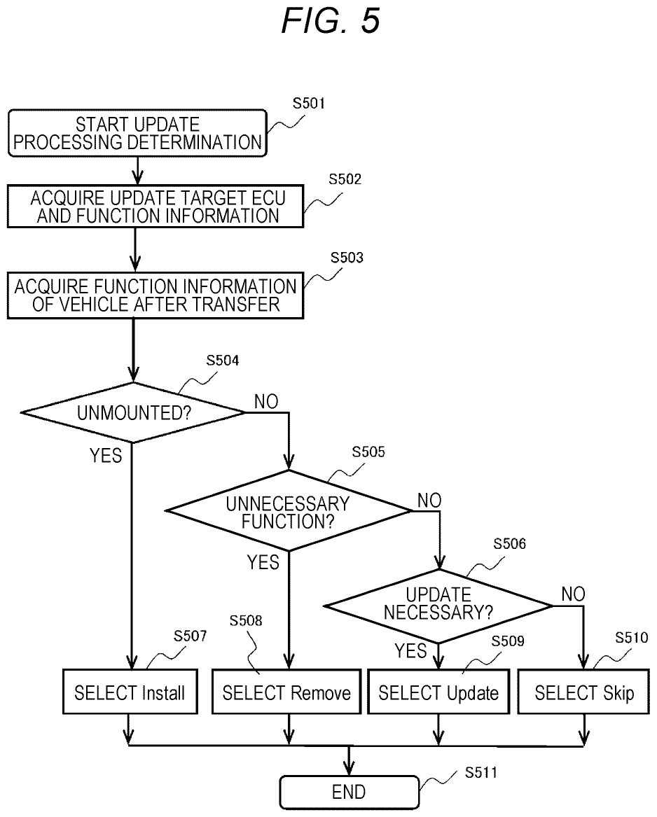

The operation of the difference extraction unit 104 (steps S401 to S409 in FIG. 4) and the operation of the update processing determination unit 105 (steps S501 to S511 in FIG. 5) will be described with reference to the flowcharts in FIGS. 4 and 5.

First, in FIG. 4, the difference extraction unit 104 starts difference extraction processing (S401).

Next, the difference extraction unit 104 acquires vehicle-mounted function information (S402). Examples of the vehicle function mounting information include a type of function-specific ECU, function information of ECU, dependency between ECUs, a manufacturer name, a vehicle model name, and a platform generation. Note that, in the present embodiment, the platform recommends use of a software over the air (SOTA) of the adaptive platform (AP) standardized by the standardization organization AUTOSAR, and a compatible version of the adaptive platform is included in the determination item.

In S403, the difference extraction unit 104 determines the manufacturer, the vehicle type, and the platform generation, and when the compatibility (OK) is enabled (YES), the processing of the difference extraction unit 104 proceeds to S404. In the case of the incompatibility (NG) (No), the processing of the difference extraction unit 104 proceeds to S408.

In S404, the difference extraction unit 104 compares and extracts the mounted function and the user-selected function. A specific extraction method is as described in FIG. 3.

In S405, the difference extraction unit 104 selects a function-specific ECU and software related to the extraction function.

Next, in S406, the update processing determination unit 105 performs resource determination. Examples of the resource include a hardware resource necessary for executing the extraction function, for example, a sensor configuration, a software resource, for example, a software version, and a required memory size. It is assumed that the information used for the resource determination is included in a part of the vehicle function mounting information. When the resource determination is OK (YES), the processing of the difference extraction unit 104 proceeds to S407. When the resource determination is NG (No), the processing of the difference extraction unit 104 proceeds to S408.

In S407, the difference extraction unit 104 determines the target ECU and the update software.

In step S408, the difference extraction unit 104 determines that the determination condition is not satisfied and makes a non-correspondence notification. That is, in S408, the update processing is cancelled. Then, the user is notified of cancellation of the update processing as a non-correspondence notification.

As described above, the difference extraction processing ends by the difference extraction unit 104 (S409).

Next, the update processing determination of FIG. 5 will be described. In FIG. 5, the update processing determination unit 105 starts update processing determination (S501).

The update processing determination unit 105 acquires the target ECU and the function information from the result of the difference extraction processing described with reference to FIG. 4 (S502), and acquires the function information of the vehicle 200 after transfer (S503). In S504, the update processing determination unit 105 checks whether or not the function is the unmounted function of the vehicle 200 after transfer, and if the function is unmounted (YES), the processing of the update processing determination unit 105 proceeds to S507. If NO (mounted) in S504, the processing of the update processing determination unit 105 proceeds to S505. In S505, the update processing determination unit 105 checks whether or not the function is unnecessary for the vehicle 200 after transfer, and if the function is unnecessary (YES), the processing of the update processing determination unit 105 proceeds to S508. If NO (necessary function) in S505, the processing of the update processing determination unit 105 proceeds to S506. In S506, the update processing determination unit 105 checks whether or not update such as version upgrade is necessary, and if update is necessary (YES), the processing of the update processing determination unit 105 proceeds to S509. In S506, if the update is unnecessary (NO), the processing of the update processing determination unit 105 proceeds to S510.

The update processing determination unit 105 selects new addition “Install” in S507, and selects removal (Remove) in S508. The update processing determination unit 105 selects update (Update) in S509, and selects no processing (Skip) in S510. Thereafter, the update processing determination by the update processing determination unit 105 ends (S511). That is, the update processing determination unit 105 is configured to be able to select the type of the software update processing from addition (Install), update (Update), removal (Remove), and skip (Skip).

Therefore, each function-specific ECU (for example, automatic driving ECU 206, brake ECU 208, and engine ECU 210) mounted on the vehicle 200 after transfer executes the software update processing using each update processing unit (207, 209, 211) in accordance with the instruction from the software update determination unit 205. That is, each update processing unit (207, 209, 211) can execute new addition (Install), removal (Remove), update (Update), and no processing (Skip). In accordance with an instruction from the software update determination unit 205, each update processing unit (207, 209, 211) performs an instructed one of new addition (Install), removal (Remove), update (Update), and no processing (Skip).

### Second Embodiment

A vehicle software update system according to a second embodiment will be described with reference to FIGS. 6 to 8.

In the first embodiment, a case where the update target ECU is only the automatic driving ECU 206 has been described, but in the second embodiment, an example of a case where a plurality of ECUs are updated will be described. Note that the vehicle software update system of the second embodiment can use the vehicle software update system of the first embodiment described with reference to FIGS. 1 to 5. In addition, since the vehicle software update system of the second embodiment operates similarly to the vehicle software update system of the first embodiment described with reference to FIGS. 1 to 5, redundant description will be omitted.

FIG. 6 illustrates an example of priority setting of each function-specific ECU according to the second embodiment. FIG. 6 is an example of priority setting of the function-specific ECU mounted on the vehicle 200 after transfer, and illustrates an example of an ECU type 600, a setting function 610, an update target 620, and various priorities 630. In this example, the ECU type 600 describes an engine ECU 60A (corresponding to 210 in FIG. 1), a brake ECU 60B (corresponding to 208 in FIG. 1), a steering ECU 60C (corresponding to 206 in FIG. 1), an automatic driving ECU 60D, a mechanical system (mechanical system) control ECU 60E, and an information system ECU 60F. In this example, the setting function 610 describes engine control 61A, brake sensitivity 61B, steering sensitivity 61C, driving assistance/automatic driving 61D, seat position and mirror position 61E, and car navigation/air conditioner (car navigation system/air conditioner) 61F. In this example, the update target 620 describes data and a program 62A, a program 62B, and data 62C.

The various priorities 630 can be classified according to factors to be emphasized, such as vehicle function emphasis 63A, safety emphasis 63B, update size emphasis 63C, and user setting emphasis 63D. Note that the numbers (1 to 6) described in the various priorities 630 have higher priorities in ascending order (priorities: 1>2>3>4>5>6). As illustrated in FIG. 6, it can be seen that the appropriate priority changes depending on factors emphasized (63A, 63B, 63C, 63D). Note that the numerical value (1 to 6
) of the priority illustrated in FIG. 6 is given as one representative example to describe the present embodiment, and the present invention is not limited thereto.

In the second embodiment, as illustrated in FIG. 6, it is assumed that the priority setting method 640 can be selected from initial setting (1) 641, initial setting (2) 642, automatic determination 643, and user setting 644.

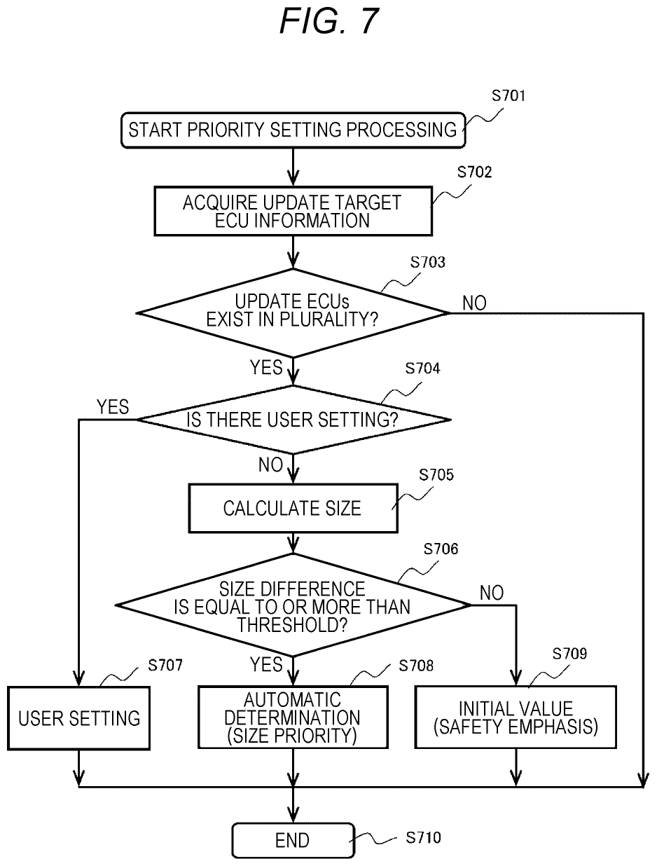

The priority setting processing (steps S701 to S710 in FIG. 7) will be described with reference to the flowchart in FIG. 7. The priority setting is performed by the software update determination unit 205 of the vehicle 200 after transfer.

The software update determination unit 205 starts priority setting processing (S701). Next, the software update determination unit 205 acquires update target ECU information (S702). In S703, the software update determination unit 205 checks whether or not update ECUs exist in plurality. In S703, if the update ECUs exist in plurality (YES), the processing of the software update determination unit 205 proceeds to S704. In S703, if the update ECUs do not exist in plurality (NO), the processing of the software update determination unit 205 ends because the priority determination is unnecessary (S710). In S704, the software update determination unit 205 checks whether or not the priority setting is included in the user setting data area 403. In S704, if there is user setting (YES), the processing of the software update determination unit 205 proceeds to S707. In S704, if there is no user setting (NO), the processing of the software update determination unit 205 proceeds to S705.

In S705, the software update determination unit 205 calculates the update size of each update target ECU. In a case where the difference between the update sizes is small, there is little merit of giving priority to the update size, and thus, the software update determination unit 205 checks whether the difference is equal to or larger than a preset threshold (for example, 1 Mbyte or more) (S706). If the difference between the update sizes is equal to or larger than the threshold (YES), the processing of the software update determination unit 205 proceeds to S708. If the difference between the update sizes is within the threshold (NO), the processing of the software update determination unit 205 proceeds to S709.

In S707, the software update determination unit 205 sets the priority setting method 640 to the user setting 644. In S708, the software update determination unit 205 sets the priority setting method 640 to the automatic determination 643. In the automatic determination 643, the update priority order is set in descending order of the update size. The reason for setting the priority based on the update size is to reduce the probability of an update failure.

In S709, the software update determination unit 205 sets the priority setting method 640 to the initial value (2) 642 (safety emphasis 63B). Note that the initial value (2) 642 can be changed to the initial value (1) 641 or another initial value setting. In the present embodiment, the initial value of the priority setting method 640 is designated as the initial value (2) 642 of the safety emphasis 63B in order to secure the safety as the vehicle function when the update fails in the middle.

After completion of each setting, the priority setting processing by the software update determination unit 205 ends (S710).

Therefore, the software update determination unit 205 is configured to be able to control the software update and the priority in the plurality of function-specific electronic control units 206, 208, and 210 as described in P15 of FIG. 2.

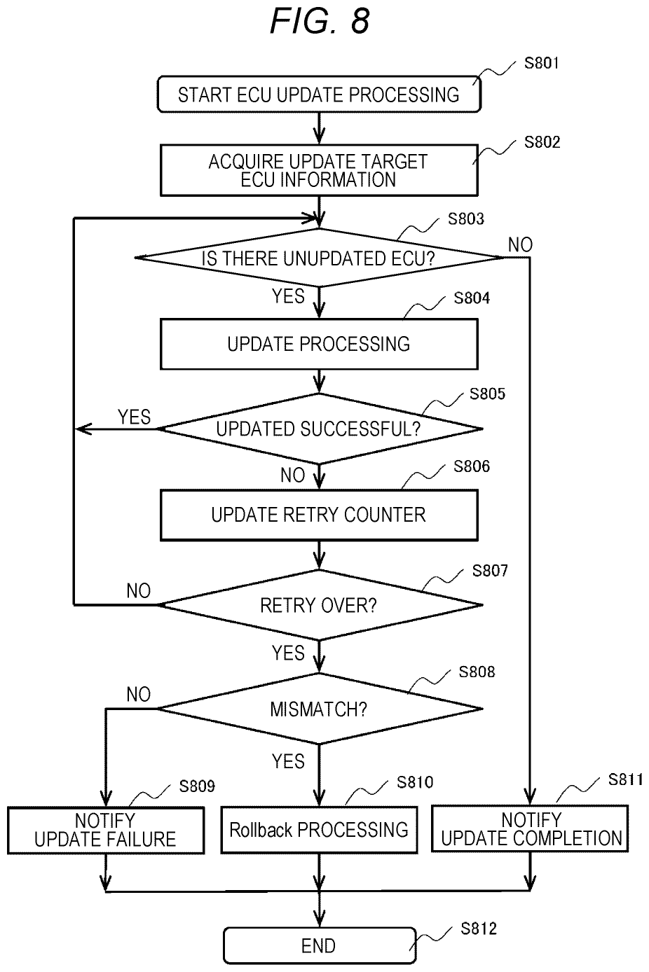

FIG. 8 is a flowchart for explaining ECU update processing according to the second embodiment. The ECU update processing (steps S801 to S812) will be described with reference to FIG. 8. The ECU update processing is performed by the software update determination unit 205 of the vehicle 200 after transfer.

The software update determination unit 205 starts ECU update processing (S801). First, the software update determination unit 205 acquires update target ECU information (S802). The update order of each ECU follows the priority setting determined in the flowchart of FIG. 7. For example, when the update target ECUs are three of the automatic driving ECU 206, the brake ECU 208, and the engine ECU 210 illustrated in FIG. 1, and the priority setting method 640 in FIG. 6 is the automatic determination 643 (update size emphasized 63C), the automatic driving ECU 206 is updated first, then the engine ECU 210 is updated, and the brake ECU 208 is updated last in this order.

In S803, the software update determination unit 205 checks the update target ECU. If there is an unupdated ECU in S803 (YES), the processing of the software update determination unit 205 proceeds to S804. If there is no unupdated ECU in S803 (NO), the processing of the software update determination unit 205 proceeds to S811.

In S804, each function-specific ECU (automatic driving ECU 206, brake ECU 208, engine ECU 210) executes update processing using each update processing unit (207, 209, 211) in accordance with an instruction from the software update determination unit 205. In S805, the software update determination unit 205 checks whether or not the update processing is successful. If the update processing is successful in S805 (YES), the processing of the software update determination unit 205 returns to S803. If the update processing fails in S805 (NO), the processing of the software update determination unit 205 proceeds to S806. Normally, in a case where a plurality of ECUs are updated, there is a high possibility that the update fails.

In S806, the software update determination unit 205 updates a retry counter in order to execute retry processing (update processing again) from the function-specific ECU for which the update processing has failed. That is, the retry counter counts the number of times of retry. Then, the processing of the software update determination unit 205 proceeds to S807. In S807, the software update determination unit 205 checks the counter value of the retry counter. If the counter value of the retry counter exceeds a preset counter value (for example, 2) (YES), the processing of the software update determination unit 205 proceeds to S808. If the counter value of the retry counter does not exceed the preset counter value (for example, 2) (NO), the processing of the software update determination unit 205 returns to S803. As a result, the retry processing of the function-specific ECU for which the update processing has failed is executed.

In S808, when the retry processing exceeds the predetermined number of times of retry (this example indicates a case where the counter value of the retry counter exceeds 2), the software update determination unit 205 checks the mismatch among the plurality of function-specific ECUs. Specifically, the check of the mismatch among the plurality of function-specific ECUs is processing of checking whether or not the update of all the function-specific ECUs having dependency has been completed. That is, when the update fails in any of the plurality of function-specific ECUs, by checking whether or not the update of all the function-specific ECUs having dependency has been completed, it is possible to determine mismatch of the update and unupdate (update failure) among all the function-specific ECUs having dependency. In S808, if there is a mismatch (YES), the processing of the software update determination unit 205 proceeds to S810. In S808, if there is no mismatch (NO), the processing of the software update determination unit 205 proceeds to S809. The dependency among the function-specific ECUs can be acquired from the mounted function information. For example, when the update target ECUs are three of the automatic driving ECU 206, the brake ECU 208, and the engine ECU 210, the automatic driving ECU 206 and the brake ECU 208 have dependency, and the engine ECU 210 does not have dependency with other ECUs (206, 208). In this case, the mismatch occurs when either the automatic driving ECU 206 or the brake ECU 208 fails in updating.

In S809, the software update determination unit 205 transmits an update failure notification. In this case, update of some ECUs is not completed.

In S810, the software update determination unit 205 executes Rollback processing for returning all the ECUs having dependency to the original software state (software state before update). By executing Rollback processing, it is possible to avoid a mismatch state among all ECUs having dependency.

In S811, the software update determination unit 205 transmits an update completion notification. This is a case where all the ECUs have been successfully updated.

Thus, the ECU update processing ends (S812).

### Third Embodiment

A vehicle software update system according to a third embodiment will be described.

The user terminal 400 is not a dedicated terminal or a portable terminal, but an in-vehicle terminal or a navigation terminal having a panel unit mounted inside the vehicle 200 after transfer or the vehicle 300 before transfer can be used. A panel unit of an in-vehicle terminal or a navigation terminal can be used as an input unit. By using these, an input operation of the user-selected function information can be performed inside the vehicle 200 after transfer or the vehicle 300 before transfer. For example, an input/output device as a panel unit of a navigation terminal mounted on a vehicle can be used as the user-selected function information input unit 402 described in FIG. 1. Since an in-vehicle terminal or a navigation terminal provided in the vehicle (300, 200) can be used, it is not necessary to separately purchase a dedicated terminal or a portable terminal, and thus the vehicle software update system can be constructed at a relatively low cost.

In the software update system of the present disclosure, the function (101 to 106) of the server 100, the function (202 to 205, 207, 209, 211) of the vehicle 200, the function (301, 302) of the vehicle 300, and the function (401 to 403) of the user terminal 400 may be configured by a hardware circuit formed on a semiconductor substrate. They may be configured by software executed by the CPU. Alternatively, they may be configured using both a hardware circuit and software.

### Modification

The present disclosure is not limited to the above-described embodiments, and includes various modifications. For example, the above-described embodiments have been described in detail for easy understanding of the present disclosure, and the present disclosure is not necessarily limited to those having all the described configurations. In addition, a part of the configuration of a certain embodiment can be replaced with the configuration of another embodiment, and the configuration of another embodiment can be added to the configuration of a certain embodiment. In addition, a part of the configuration of each embodiment may be added, deleted, or replaced with another configuration.

### REFERENCE SIGNS LIST

10 vehicle software update system
20 network
100 center (OTA server)
101 vehicle/user authentication processing unit
102 vehicle-mounted function information receiving unit
103 user-selected function receiving unit
104 difference extraction unit
105 update processing determination unit
106 update function information transmission unit
200 vehicle after transfer
201 vehicle control device (software update control device)
202 vehicle authentication processing unit
203 mounted function information transmission unit
204 update function information receiving unit
205 software update determination unit
206 automatic driving ECU
207 update processing unit of automatic driving ECU
208 brake ECU
209 update processing unit of brake ECU
210 engine ECU
211 update processing unit of engine ECU
300 vehicle before transfer
301 vehicle authentication processing unit
302 mounted function information transmission unit
400 user terminal
401 user authentication processing unit
402 user-selected function information input unit
403 user setting data area
600 ECU type
610 setting function
620 update target
630 various priorities
640 priority setting method
641 initial setting (1)
642 initial setting (2)
643 automatic determination
644 user setting

1. A vehicle software update system comprising:
a vehicle control device mounted on a vehicle; and a server that performs communication via a network,
the vehicle including a vehicle before transfer and a vehicle after transfer, and
the vehicle software update system managing software updates of a plurality of function-specific electronic control units in the vehicle after transfer, wherein
the server includes:
an acquisition unit A that acquires mounted function information of the vehicle before transfer;
an acquisition unit B that acquires mounted function information of the vehicle after transfer;
an acquisition unit C that acquires user-selected function information from a user terminal;
a difference extraction unit that extracts a difference among the mounted function information of the vehicle before transfer, the mounted function information of the vehicle after transfer, and the user-selected function information; and
an update processing determination unit that selects necessary software update processing according to the content of the difference and generates update function information based on the necessary software update processing, and
in the vehicle after transfer,
the vehicle control device includes a software update determination unit that controls software update and priority in the plurality of function-specific electronic control units according to the update function information distributed from the server, and
each of the plurality of function-specific electronic control units includes a software update processing unit that executes a software update method notified from the vehicle control device of the vehicle after transfer.

2. The vehicle software update system according to claim 1, wherein
the difference extraction unit determines a platform, and when a determination condition is not satisfied, the difference extraction unit stops the update processing and notifies the user of the stop.

3. The vehicle software update system according to claim 1, wherein
the difference extraction unit performs resource determination of an ECU, and when a determination condition is not satisfied, stops the update processing and notifies the user.

4. The vehicle software update system according to claim 1, wherein
the update processing determination unit selects a type of the software update processing from addition, update, removal, and skip.

5. The vehicle software update system according to claim 1, wherein
the user terminal is a portable terminal carried by a user.

6. The vehicle software update system according to claim 1, wherein
the user terminal can perform an input operation inside the vehicle before transfer or the vehicle after transfer.

7. The vehicle software update system according to claim 1, wherein
in a case where there are a plurality of update targets in the plurality of function-specific electronic control units, the vehicle control device of the vehicle after transfer enables, in setting of the priority, selection of user setting, automatic determination, and initial setting of safety emphasis in the software update determination unit.

8. The vehicle software update system according to claim 7, wherein
in the automatic determination, an update priority order is set in descending order of an update size from among target electronic control units, and
when a difference between the update sizes is within a preset threshold, the initial setting of safety emphasis can be selected.

9. The vehicle software update system according to claim 1, wherein
the software update processing unit of each of the plurality of function-specific electronic control units makes it possible to execute addition, update, removal, and skip as the software update processing.

10. The vehicle software update system according to claim 1, wherein
the software update determination unit of the vehicle control device of the vehicle after transfer
when the update fails in any of the plurality of function-specific electronic control units, checks whether or not the update of all the function-specific electronic control units having dependency has been completed, and determines mismatch of update and unupdate among all the function-specific electronic control units having dependency;
executes retry processing in order to perform an update again on the function-specific electronic control unit for which the update has failed; and
when the retry processing exceeds a predetermined number of times of retry, executes Rollback processing for returning all the function-specific electronic control units having dependency to an original software state.
